(19) United States
(12) Patent Application Publication
(10) Pub. No.: US 2013/0106757 A1
(43) Pub. Date: May 2, 2013

(54) FIRST RESPONSE AND SECOND RESPONSE

(71) Applicants: Reed Hablinski, Houston, TX (US); Robert Campbell, Cupertino, CA (US)

(72) Inventors: Reed Hablinski, Houston, TX (US); Robert Campbell, Cupertino, CA (US)

(73) Assignee: HEWLETT-PACKARD DEVELOPMENT COMPANY, L.P., Fort Collins, CO (US)

(21) Appl. No.: 13/809,162

(22) PCT Filed: Jul. 15, 2010
(86) PCT No.: PCT/US2010/042082

§ 371 Date: Jan. 8, 2013

(51) Int. Cl. G06F 3/041

(52) U.S. Cl. CPC G06F 3/041
USPC 345/173

(57) ABSTRACT

A method for detecting an input including identifying a first user based on a first position and a second user based on a second position with a sensor, providing a first response from a computing machine in response to the sensor detecting a first user input from the first user, and providing a second response from the computing machine in response to the sensor detecting a second user input from the second user.

### BACKGROUND

When one or more users are interacting with a device, a first user can initially take control of the device and access the device. The first user can input one or more commands on the device and the device can provide a response based on inputs from the first user. Once the first user has finished accessing the device, a second user can proceed to take control of the device and access the device. The second user can input one or more commands on the device and the device can provide a response based on inputs from the second user. This process can repeated for one or more users.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a computing machine with a sensor according to an embodiment of the invention.

FIG. 2 illustrates a computing machine identifying a first user based on a first position and a second user based on a second position according to an embodiment of the invention.

FIG. 3 illustrates a block diagram of a response application identifying a first response based on a first user input and a second response based on a second user input according to an embodiment of the invention.

FIG. 4 illustrates a block diagram of a response application providing a first response based on a first user input and a second response based on a second user input according to an embodiment of the invention.

FIG. 5 illustrates a response application on a computing machine and a response application stored on a removable medium being accessed by the computing machine according to an embodiment of the invention.

FIG. 6 is a flow chart illustrating a method for detecting an input according to an embodiment of the invention.

FIG. 7 is a flow chart illustrating a method for detecting an input according to another embodiment of the invention.

### DETAILED DESCRIPTION

By utilizing a sensor to identify a first user based on a first position and a second user based on a second position, a computing machine can detect a first user input based on the first position and detect a second user input based on the second position. Additionally, by providing a first response from the computing machine in response to the first user input and providing a second response in response to the second user input, different user experiences can be created for one or more users in response to the users interacting with the computing machine.

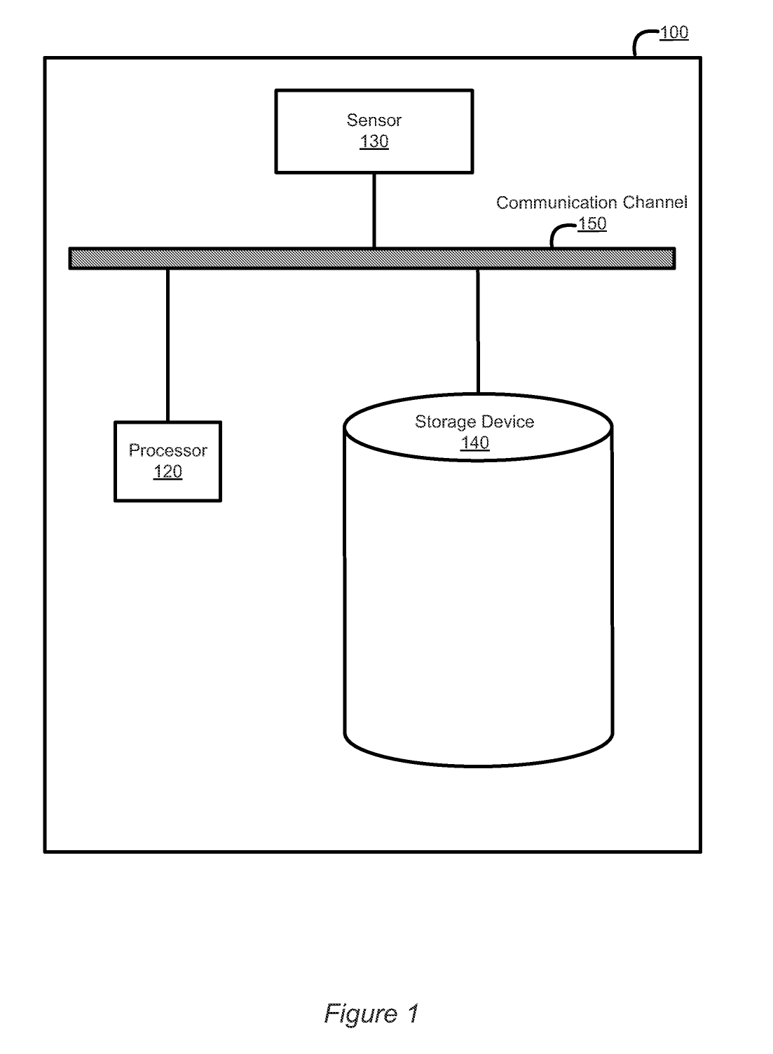

FIG. 1 illustrates a computing machine 100 with a sensor 130 according to an embodiment of the invention. In one embodiment, the computing machine 100 is a desktop, a laptop, a tablet, a netbook, an all-in-one system, and/or a server. In another embodiment, the computing machine 100 is a GPS, a cellular device, a FDA, an E-Reader, and/or any additional computing device which can include one or more sensors 130.

As illustrated in FIG. 1, the computing machine 100 includes a processor 120, a sensor 130, a storage device 140, and a communication channel 150 for the computing machine 100 and/or one or more components of the computing machine 100 to communicate with one another. In one embodiment, the storage device 140 is additionally configured to include a response application. In other embodiments, the computing machine 100 includes additional components and/or is coupled to additional components in addition to and/or in lieu of those noted above and illustrated in FIG. 1.

As noted above, the computing machine 100 includes a processor 120. The processor 120 sends data and/or instructions to the components of the computing machine 100, such as the sensor 130 and the response application. Additionally, the processor 120 receives data and/or instructions from components of the computing machine 100, such as the sensor 130 and the response application.

The response application is an application which can be utilized in conjunction with the processor 120 to control or manage the computing machine 100 by detecting one or more inputs. When detecting one or more inputs, a sensor 130 identifies a first user based on a first position and the sensor 130 identifies a second user based on a second position. For the purposes of this application, a user can be any person which can be detected by the sensor 130 to be interacting with the sensor 130 and/or the computing machine 100. Additionally, a position of a user corresponds to a location of the user around an environment of the sensor 130 or the computing machine 100. The environment includes a space around the sensor 130 and/or the computing machine 100.

Additionally, the processor 120 and/or the response application configure the computing machine 100 to provide a first response in response to the sensor 130 detecting a first user input from the first user. Further, the computing machine 100 can be configured to provide a second response in response to the sensor 130 detecting a second user input from the second user. For the purposes of this application, an input includes a voice action, a gesture action, a touch action, and/or any additional action which the sensor 130 can detect from a user. Additionally, a response includes any instruction or command which the processor 120, the response application, and/or the computing machine 100 can execute in response to detecting an input from a user.

The response application can be firmware which is embedded onto the processor 120, the computing machine 100, and/or the storage device 140. In another embodiment, the response application is a software application stored on the computing machine 100 within ROM or on the storage device 140 accessible by the computing machine 100. In other embodiments, the response application is stored on a computer readable medium readable and accessible by the computing machine 100 or the storage device 140 from a different location.

Additionally, in one embodiment, the storage device 140 is included in the computing machine 100. In other embodiments, the storage device 140 is not included in the computing machine 100, but is accessible to the computing machine 100 utilizing a network interface included in the computing machine 100. The network interface can be a wired or wireless network interface card. In other embodiments, the storage device 140 can be configured to couple to one or more ports or interfaces on the computing machine 100 wirelessly or through a wired connection.

In a further embodiment, the response application is stored and/or accessed through a server coupled through a local area network or a wide area network. The response application communicates with devices and/or components coupled to the computing machine 100 physically or wirelessly through a communication bus 150 included in or attached to the computing machine 100. In one embodiment the communication bus 150 is a memory bus. In other embodiments, the communication bus 150 is a data bus.

As noted above, the processor 120 can be utilized in conjunction with the response application to manage or control the computing machine 100 by detecting one or more inputs from users. At least one sensor 130 can be instructed, prompted and/or configured by the processor 120 and/or the response application to identify a first user based on a first position and to identify a second user based on a second position. A sensor 130 is a detection device configured to detect, scan for, receive, and/or capture information from the environment around the sensor 130 or the computing machine 100.

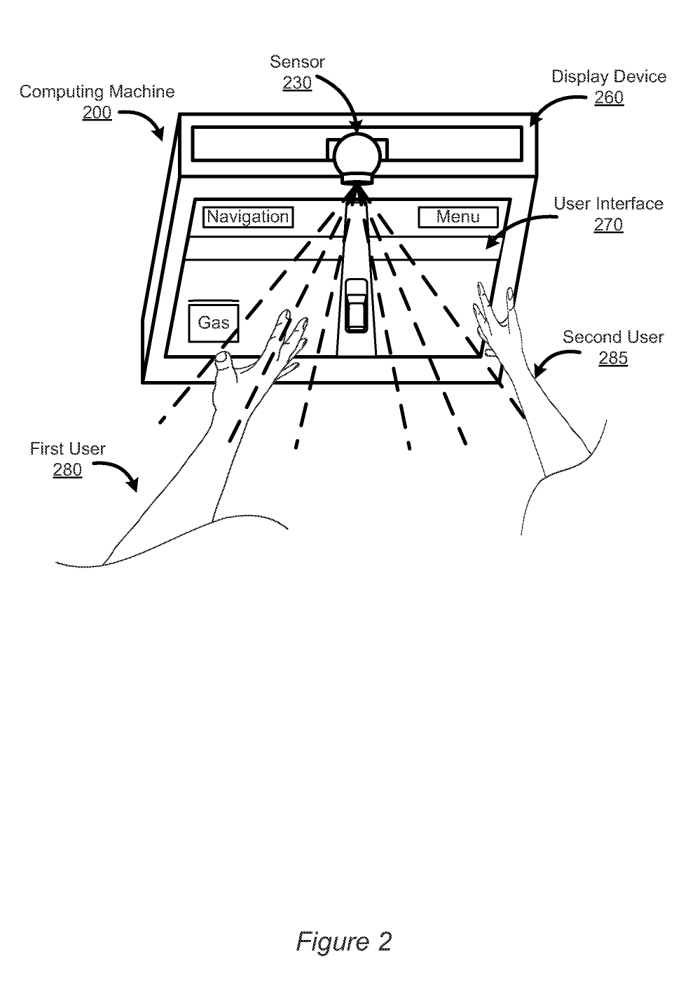

FIG. 2 illustrates a computing machine 200 identifying a first user 280 based on a first position and a second user 285 based on a second position according to an embodiment of the invention. As shown in FIG. 2, a sensor 230 can detect, scan, and/or capture a view around the sensor 230 for one or more users 280, 285 and one or more inputs from the users 280, 285. The sensor 230 can be coupled to one or more locations on or around the computing machine 200. In other embodiments, a sensor 230 can be integrated as part of the computing machine 200 or the sensor 230 can be coupled to or integrated as part of one or more components of the computing machine 200, such as a display device 260.

Additionally, as illustrated in the present embodiment, a sensor 230 can be an image capture device. The image capture device can be or include a 3D depth image capture device. In one embodiment, the 3D depth image capture device can be or include a time of flight device, a stereoscopic device, and/or a light sensor. In another embodiment, the sensor 230 includes at least one from the group consisting of a motion detection device, a proximity sensor, an infrared device, a GPS, a stereo device, a microphone, and/or a touch device. In other embodiments, a sensor 230 can include additional devices and/or components configured to detect, receive, scan for, and/or capture information from the environment around the sensor 230 or the computing machine 200.

In one embodiment, a processor and/or a response application of the computing machine 200 send instructions for a sensor 230 to detect one or more users 280, 285 in the environment. The sensor 230 can detect and/or scan for an object within the environment which has dimensions that match a user. In another embodiment, any object detected by the sensor 230 within the environment can be identified as a user. In other embodiments, a sensor 230 can emit one or more signals and detect a response when detecting one or more users 280, 285.

As illustrated in FIG. 2, sensor 230 has detected a first user 280 and a second user 285. In response to detecting one or more users in the environment, the sensor 230 notifies the processor or the response application that one or more users are detected. The sensor 230 will proceed to identify a first position of a first user and a second position of a second user. When identifying a position of one or more users, the sensor 230 detects a location or a coordinate of one or more of the users 280, 285 within the environment. In another embodiment, as illustrated in FIG. 2, the sensor 230 actively scans or detects a viewing area of the sensor 230 within the environment for the location the users 280, 285.

In other embodiments, the sensor 230 additionally detects an angle of approach of the users 280, 285, relative to the sensor 230. As shown in FIG. 2, the sensor 230 has detected the first user 280 at a position to the left of the sensor 230 and the computing machine 200. Additionally, the sensor 230 has detected the second user 285 at a position to the right of the sensor 230 and the computing machine 200. In other embodiments, one or more of the users can be detected by the sensor 230 to be positioned at additional locations in addition to and/or in lieu of those noted above and illustrated in FIG. 2.

The sensor 230 will transfer the detected or captured information of the position of the users 280, 285 to the processor and/or the response application. The position information of the first user 280, the second user 285, and any additional user can be used and stored by the processor or the response application to assign a first position for the first user 280, a second position 285 for the second user, and so forth for any detected users. In one embodiment, the processor and/or the response application additionally create a map of coordinates and mark the map to represent where the users 280, 285, are detected. Additionally, the map of coordinates can be marked to show the angle of the users 280, 285, relative to the sensor 130. The map of coordinates can include a pixel map, bit map, and/or a binary map.

Once a position has been identified for one or more users, the sensor 230 proceeds to detect a user input from one or more of the users. When detecting an input, the sensor 230 can detect, scan for, and/or capture a user interacting with the sensor 230 and/or the computing machine 200. In other embodiments, one or more sensors 230 can be utilized independently or in conjunction with one another to detect one or more users 280, 285 and the users 280, 285 interacting with the display device 260 and/or the computing machine 200.

As illustrated in FIG. 2, the computing machine 200 can include a display device 260 and the users 280, 285 can interact with the display device 260. The display device 260 can be an analog or a digital device configured to render, display, and/or project one or more pictures and/or moving videos. The display device 260 can be a television, monitor, and/or a projection device. As shown in FIG. 2, the display device 260 is configured by the processor and/or the response application to render a user interface 270 for the users 280, 285 to interact with. The user interface 270 can display one or more objects, menus, images, videos, and/or maps for the users 280, 285 to interact with. In another embodiment, the display device 260 can render more than one user interface.

A first user interface can be rendered for the first user 280 and a second user interface can rendered for the second user 285. The first user interface can be rendered in response to the first user position and the second user interface can be rendered in response to the second user position. The first user interface and the second user interface can be the same or they can be rendered different from one another. In other embodiments, the display device 260 and/or the computing machine 200 can be configured to output audio for the users 280, 285 to interact with.

When a user is interacting with the user interface 270 or any component of the computing machine 200, the sensor 230 can detect one or more actions from the user. As illustrated in FIG. 2, the action can include a gesture action or a touch action. The sensor 230 can detect a gesture action or touch action by detecting one or more motions made by a user. Additionally, the sensor 340 can detect a touch action by detecting a user touching the display device 260, the user interface 270, and/or any component of the computing machine 200. In another embodiment, the action can include a voice action and the sensor 230 can detect the voice action by detecting any noise, voice, and/or words from a user. In other embodiments, a user can make any additional action detectable by the sensor 230 when interacting with the user interface 270 and/or any component of the computing machine 200.

Additionally, when determining which of the users 280, 285 is interacting with the user interface 270 or a component of the computing machine 200, the processor and/or the response application will determine whether an action is detected from a first position, a second position, and/or any additional position. If the action is detected from the first position, the processor and/or the response application will determine that a first user input has been detected from the first user 280. Additionally, if the action is detected from the second position, a second user input will have been detected from the second user 285. The processor and/or the response application can repeat this method to detect any inputs from any additional users interacting with the sensor 230 or the computing machine 200.

As illustrated in FIG. 2, the sensor 230 has detected a gesture action from the first position and the second position. Additionally, the sensor 230 detects that a first gesture action is made with a hand of the first user 280 and a second gesture action is detected from a hand of the second user 285. As a result, the processor and/or the response application determine that a first user input and a second user input have been detected. In one embodiment, the sensor 230 additionally detects an orientation of a hand or finger of the first user 280 and the second user 285 when detecting the first user input and the second user input.

In another embodiment, the sensor 230 further detects an angle of approach of the gesture actions from the first position and the second position, when detecting the first user input and the second user input. The sensor 230 can detect a viewing area of 180 degrees in front of the sensor 230. If an action is detected from 0 to 90 degrees in front of the sensor 230, the action can be detected as a first user input. Additionally, if the action is detected from 91 to 180 degrees in front of the sensor 230, the action can be detected as a second user input. In other embodiments, additional ranges of degrees can be defined for the sensor 230 when detecting one or more inputs from a user.

In response to detecting the first user input, the processor and/or the response application proceed to identify the first user input and configure the computing machine 200 to provide a first response based on the first user input and the first user position. Additionally, the processor and/or the response application configure the computing machine 200 to provide a second response based on the second user input and the second user position. In one embodiment, the user interface 270 is additionally configured to render the first response and/or the second response.

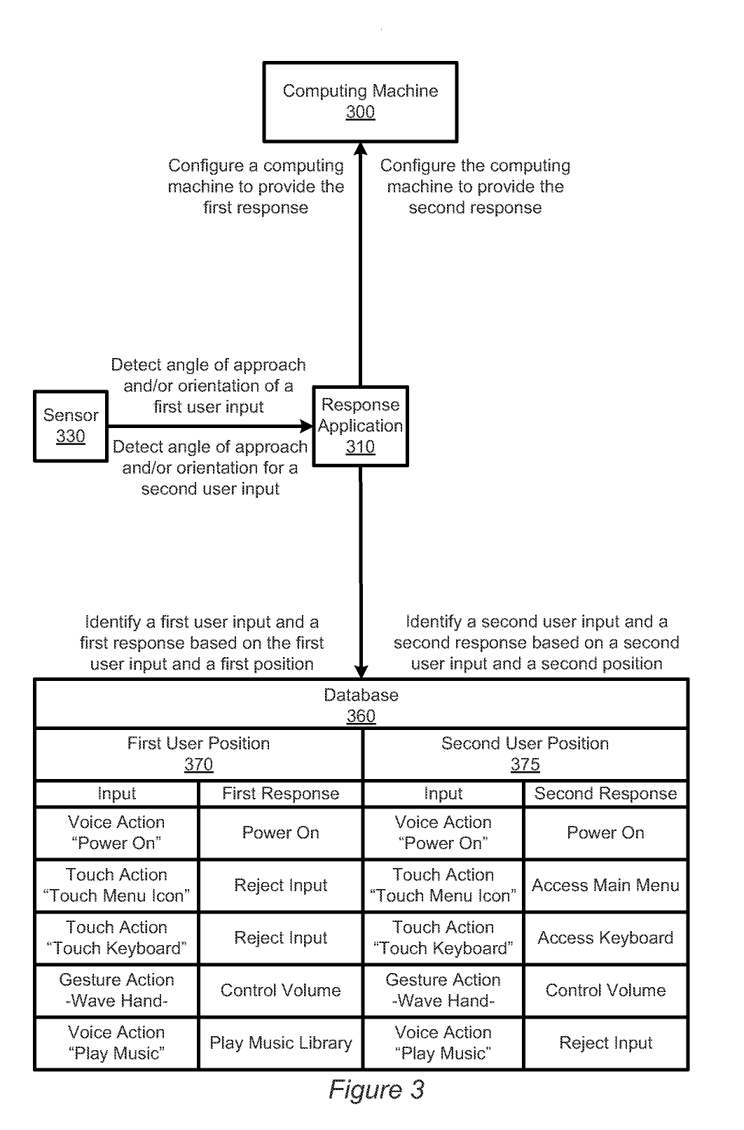

FIG. 3 illustrates a block diagram of a response application 310 identifying a first response based on a first user input and a second response based on a second user input according to an embodiment of the invention. As illustrated in FIG. 3, a sensor 330 can detect an angle of approach and/or an orientation of a first user input from a first user. Additionally, the sensor 330 can detect an angle of approach and/or an orientation of a second user input from a second user. Further, the sensor 330 sends the response application 310 information of the first user input and the second user input.

Once the response application 310 has received the detected information, the response application 310 attempts to identify a first user input and a first response. Additionally, the response application 310 attempts to identify a second user input and a second response with the detected information. When identifying an input, the response application 310 utilizes information detected from the sensor 330. The information can include details of a voice action, such as one or more words or noises from the voice action. If the information includes words and/or noises, the response application 310 can additionally utilize voice detection or voice recognition technology to identify the noises and/or words from the voice action.

In another embodiment, the information can include a location of where a touch action is performed. In other embodiments, the information can specify a beginning, an end, a direction, and/or a pattern of a gesture action or touch action. Additionally, the information can identify whether an action was detected from a first user position 370 or a second user position 375. In other embodiments, the information can include additional details utilized to define or supplement an action in addition to and/or in lieu of those noted above and illustrated in FIG. 3.

Utilizing the detected information, the response application 310 accesses a database 360 to identify a first user input and a second user input. As illustrated in FIG. 3, the database 360 lists recognized inputs based on the first user position 370 and recognized inputs based on the second user position 370. Additionally, within the recognized input entries includes information for the response application 310 to reference when identifying an input. As shown in FIG. 3, the information can list information corresponding to a voice action, a touch action, and/or a gesture action. In other embodiments, the recognized inputs, the responses, and/or any additional information can be stored in a list and/or a file accessible to the response application 310.

The response application 310 can compare the information detected from the sensor 330 to the information within the entries of the database 360 and scan for a match. If the response application 310 determines that the detected information matches any of the recognized inputs listed under the first user position 370, the response application 310 will have identified the first user input. Additionally, if the response application 310 determines that the detected information matches any of the recognized inputs listed under the second user position 375, the response application 310 will have identified the second user input.

As shown in FIG. 3, next to the recognized inputs includes a response which the response application 310 can execute or provide. In response to identifying the first user input, the response application 310 proceeds to identify a first response. Additionally, in response to identifying the second user input, the response application 310 identifies a second response. As noted above and as illustrated in FIG. 3, the first response is identified based on the first user input and the first position. Additionally, the second response is identified based on the second user input and the second position. As a result, when identifying the first response, the response application 310 selects a response which is listed next to the first user input and is listed under the first user position 370 column of the database 360. Additionally, when identifying the second response, the response application 310 selects a response which is listed next to the second user input and is listed under the second user position 375 column of the database 360.

Once the first response and/or the second response have been identified, the response application 310 proceeds to configure the computing machine 300 to provide the first response and/or the second response. In other embodiments, a processor of the computing machine 300 can be utilized independently and/or in conjunction with the response application 310 to identify a first user input, a second user input, a first response, and/or a second response.

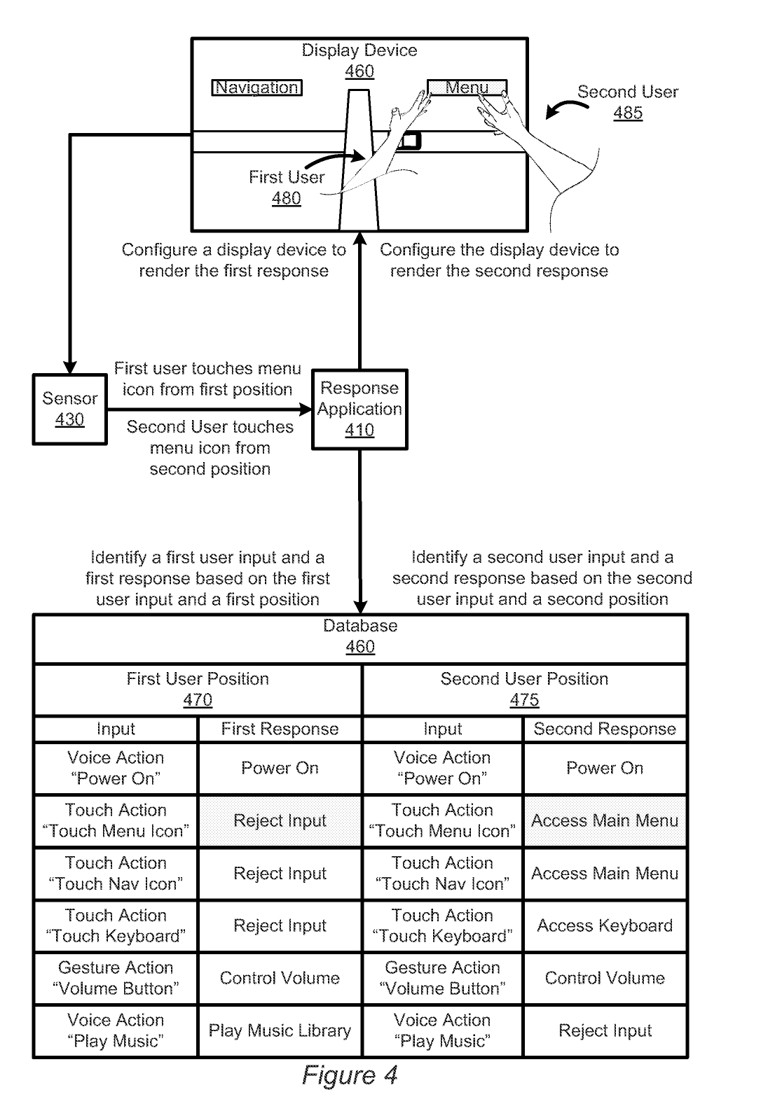

FIG. 4 illustrates a block diagram of a response application 410 providing a first response based on a first user input and a second response based on a second user input according to an embodiment of the invention. As shown in the present embodiment, a first user 480 and a second user 480 are interacting with user interface of a display device 460. Additionally, a sensor 430 has detected a first user 480 performing a touch action from the first user position. Additionally, the touch action is performed on a menu icon on the display device 460. Further, the sensor 430 has detected a second user 485 perform a touch action on the menu icon of the display device 460 from a second position. As a result, the response application 410 determines that a first user input has been detected and a second user input has been detected.

As noted above, in response to detecting the first user input and the second user input, the response application 410 accesses a database 460 to identify the first user input and the second user input. As shown in the present embodiment, the response application 410 scans a first user position 470 column of the database 460 for a recognized input that includes a touch action performed on a menu icon. The response application 410 determines that a match is found (Touch Action—Touch Menu Icon). Additionally, the response application 410 scans a second user position 475 column of the database 460 for a recognized input that includes a touch action performed on a menu icon and determines that a match is found (Touch Action—Touch Menu Icon).

As a result, the response application 410 determines that the first user input and the second user input have been identified and the response application 410 proceeds to identify a first response and/or a second response to provide the first user 480 and the second user 485. As noted above, a response includes one or more instructions and/or commands which the computing machine can be configured to execute. The response can be utilized to execute and/or reject an input received from one or more users. Additionally, when providing a response, the computing machine can access, execute, modify, and/or delete one or more files, items, and/or functions. In another embodiment, a response can be utilized to reject a user accessing, executing, modifying, and/or deleting one or more files, items, and/or functions.

As illustrated in FIG. 4, when identifying a first response and a second response, the response application 410 determines that the database 460 lists for a first response to reject the first user input and for a second response to allow the access of the main menu. As illustrated in the present embodiment, a first response can be different from a second response when the first user input and the second user input are the same. As a result, in response to the positions of the users, an experience created for the first user 480 can be different from an experience created for the second user 485 when interacting with a computing machine. In other embodiments, one or more responses for the first user and the second user can be the same.

As noted above, once the first response and the second response have been identified, the response application 410 proceeds to configure the computing machine to provide the first response and provide the second response. When configuring the computing machine to provide the first response and/or the second response, the response application 410 can send one or more instructions for the computing machine to execute an identified response. As illustrated in FIG. 4, in one embodiment, when providing the first response and the second response, the computing machine configures the display device 460 to render the first response and the second response for display.

As shown in the present embodiment, because the response application 410 previously determined that the first response included rejecting the first user input, the computing machine configures the display device 460 to render the user interface to not react to the touch action from the first user 480. In one embodiment, any touch actions or gesture actions can be rejected from the first user 480 and/or the first position.

Additionally, because the response application 410 previously determined that the second response includes accessing the main menu, the display device 460 renders the user interlace to respond to the touch action from the second user 485. In one embodiment, the display device 460 renders the user interface to render additional objects, images, and/or videos in response to the second user 485 accessing the main menu. In other embodiments, one or more components of the computing machine can be configured by the response application 410 and/or a processor to render or provide one or more audio responses, tactile feedback responses, visual responses, and/or any additional responses in addition to and/or in lieu of those noted above and illustrated in FIG. 4.

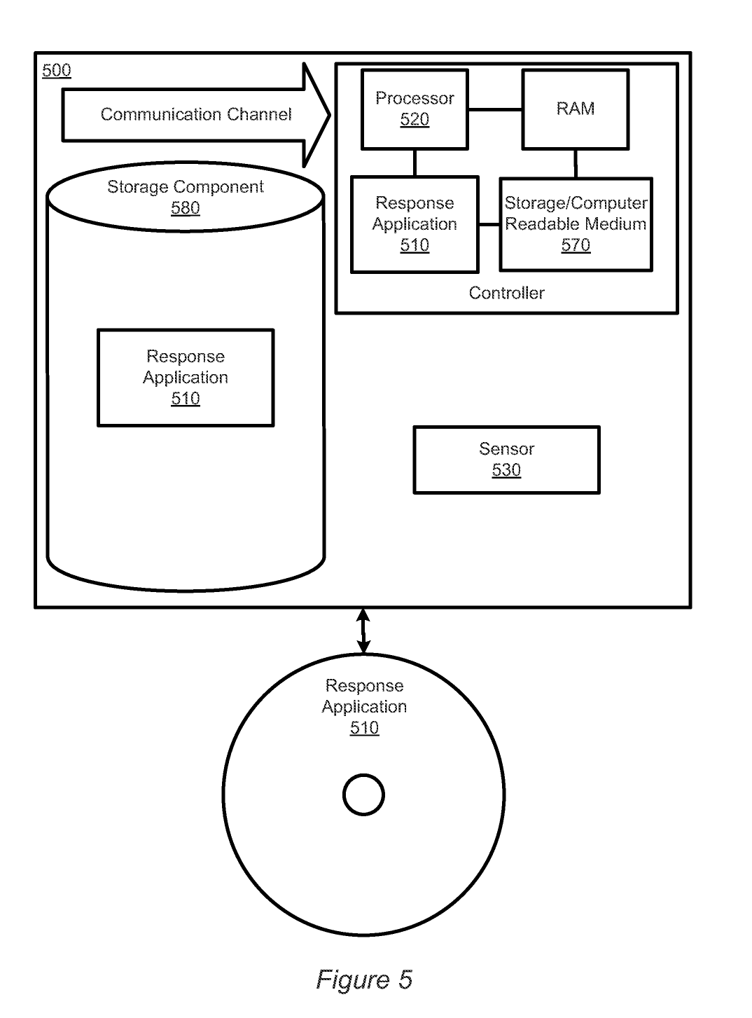

FIG. 5 illustrates a device with a response application 510 and a response application 510 stored on a removable medium being accessed by the device 500 according to an embodiment of the invention. For the purposes of this description, a removable medium is any tangible apparatus that contains, stores, communicates, or transports the application for use by or in connection with the device 500. As noted above, in one embodiment, the response application 510 is firmware that is embedded into one or more components of the device 500 as ROM. In other embodiments, the response application 510 is a software application which is stored and accessed from a hard drive, a compact disc, a flash disk, a network drive or any other form of computer readable medium that is coupled to the device 500.

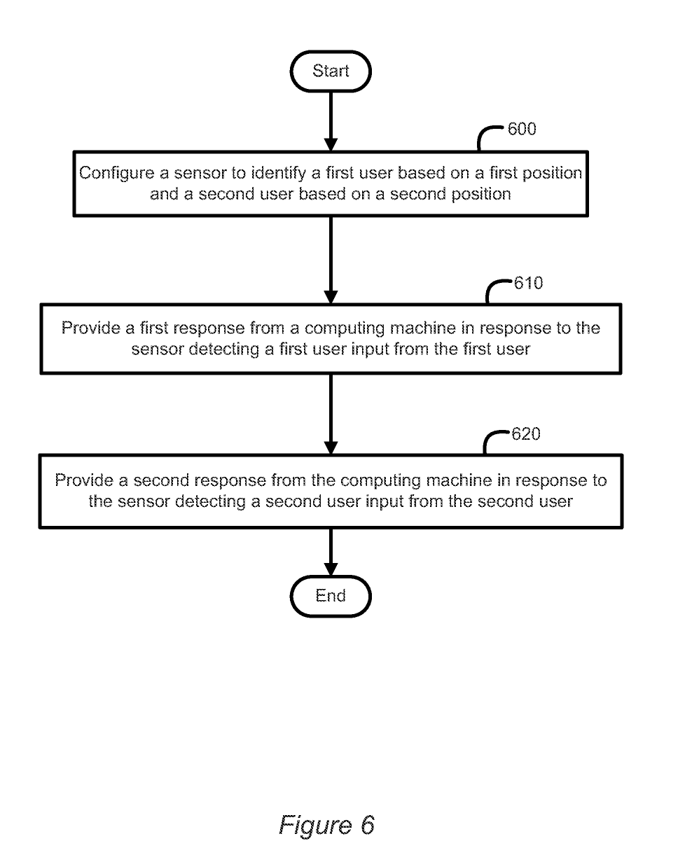

FIG. 6 is a flow chart illustrating a method for detecting an input according to an embodiment of the invention. The method of FIG. 6 uses a computing machine with a processor, a sensor, a communication channel, a storage device, and a response application. In other embodiments, the method of FIG. 6 uses additional components and/or devices in addition to and/or in lieu of those noted above and illustrated in FIGS. 1, 2, 3, 4, and 5.

As noted above, the response application is an application which can independently or in conjunction with the processor manage and/or control a computing machine in response to detecting one or more inputs from users. A user is anyone who can interact with the computing machine and/or the sensor through one or more actions. In one embodiment, the computing machine additionally includes a display device configured to render a user interface for the users to interact with. One or more users can interact with the user interface and//or the display device through one or more actions.

An action can include a touch action, a gesture action, a voice action, and/or any additional action which a sensor can detect. Additionally, a sensor is a component or device of the computing machine configured to detect, scan for, receive, and/or capture information from an environment around the sensor and/or the computing machine. In one embodiment, the sensor includes a 3D depth capturing device. When detecting users, the sensor can be instructed by the processor and/or the response application to identify a first user based on a first position and a second user based on a second position 600.

When identifying a first user and a second user, the sensor can detect one or more objects within the environment of the computing machine and proceed to identify locations and/or coordinates of objects which have dimensions which match a user. The sensor can transfer the detected information of the location or coordinate of any objects to the processor and/or the response application. In response to receiving the information, the processor and/or the response application can identify the first object as a first user, a second object as a second user, and so forth for any additional users.

Additionally, the processor and/or the response application identify a first position of the first user to be the location or coordinate of the first object, a second position of the second user to be the location or coordinate of the second object, and so forth for any additional users. As noted above, a pixel map, coordinate map, and/or binary map can additionally be created and marked to represent the users and the position of the users.

Once the processor and/or the response application have identified one or more users and corresponding positions for the users, the sensor proceeds to detect one or more actions from the users. When detecting an action, the sensor additionally detects and/or captures information of the action. The information can include a voice or noise made by a user. Additionally, the information can include any motion made by a user and details of the motion. The details can include a beginning, an end, and/or one or more a directions included in the motion. Further, the information can include any touch and a location of the touch made by the user. In other embodiment, the information can be or include additional details of an action detected by the sensor.

Additionally, the sensor further identifies whether the action is being made from a first position, a second position, and/or any additional position by detecting where the action is being performed. In one embodiment, the sensor detects where the action is being performed by detecting an angle of approach of an action. In another embodiment, the sensor further detects an orientation of a finger and/or a hand when the action is a motion action or a touch action. Once the action is detected by the sensor, the sensor can send the processor and/or the response application the detected information.

The processor and/or the response application can then identify a first user input using information detected from the first position. Additionally, the processor and/or the response application can identify a second user input using information detected from the second position. As noted above, when identifying the first user input, a database, list, and/or file can be accessed by the processor and/or the response application. The database, list, and/or file can include entries for one or more recognized inputs for each user. Additionally, the entries include information corresponding to a recognized input which the processor and/or the response application can scan when identifying an input.

The processor and/or the response application can compare the detected information from the sensor to the information in the database and scan for a match. If the processor and/or the response application determine that a recognized input has information which matches the detected information from the first position, a first user input will have been identified. Additionally, if the processor and/or the response application determine that a recognized input has information which matches the detected information from the second position, a second user input will have been identified.

In response to detecting and/or identifying a first user input from the first position, the processor and/or the response application can identify a first response and configure the computing machine to provide a first response 610. Additionally, in response to detecting and/or identifying a second user input from the second position, the processor and/or the response application can identify a second response and configure the computing machine to provide a second response 620.

As noted above, the database includes entries corresponding to the recognized inputs. The corresponding entries list a response which can be executed or provided by the computing machine. When identifying a first response, the processor and/or the response application will identify a response which is listed to be next to the recognized input identified to be the first user input. Additionally, when identifying the second response, the processor and/or the response application will identify a response which is listed to be next to the recognized input identified to be the second user input.

As noted above, a response includes one or more instructions and/or commands which the computing machine can execute. The response can be utilized to access, execute, and/or reject an input received from one or more users. When providing a response, the computing machine can be instructed by the processor and/or the response application to access, execute, modify, and/or delete one or more files, items, and/or functions. In one embodiment, the processor and/or the response application additionally configure a display device to render the first response and/or the second response. In other embodiments, if any additional users are detected and any additional inputs are detected from the additional users, the process can be repeated using one or more of the methods disclosed above. In other embodiments, the method of FIG. 6 includes additional steps in addition to and/or in lieu of those depicted in FIG. 6.

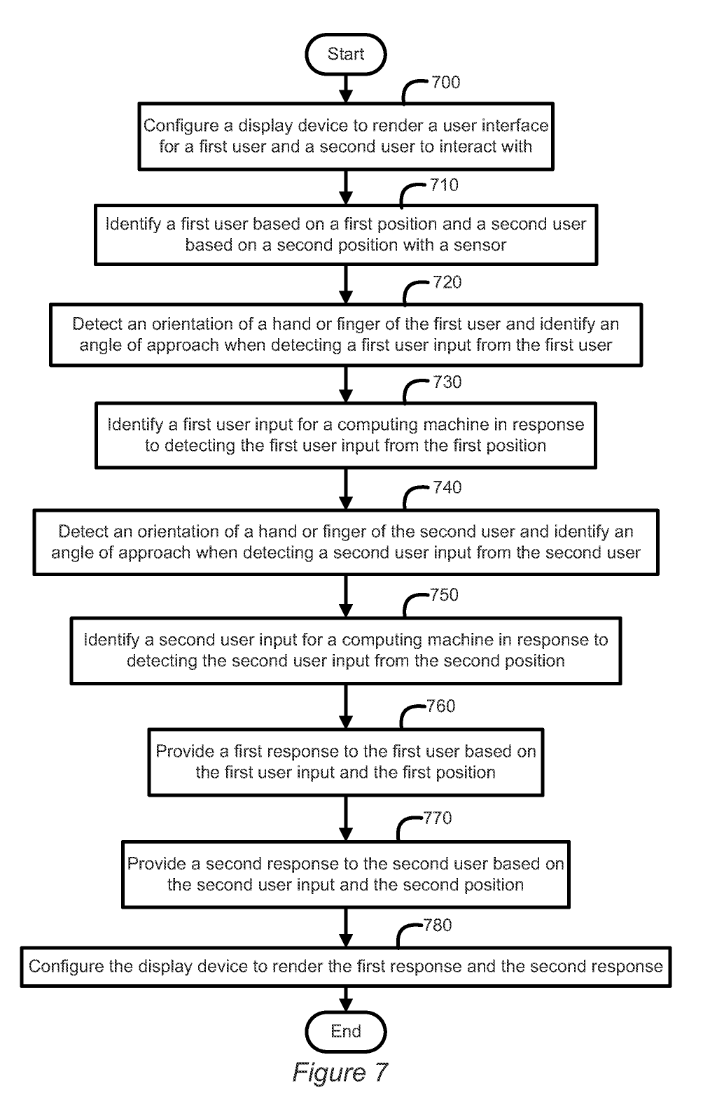

FIG. 7 is a flow chart illustrating a method for detecting an input according to another embodiment of the invention. Similar to the method disclosed above, the method of FIG. 7 uses a computing machine with a processor, a sensor, a communication channel, a storage device, and a response application. In other embodiments, the method of FIG. 7 uses additional components and/or devices in addition to and/or in lieu of those noted above and illustrated in FIGS. 1, 2, 3, 4, and 5.

In one embodiment, the computing machine additionally includes a display device. The display device is an output device configured to render one or more images and/or videos. The processor and/or the response application can configure the display device to render a user interface with one or more images and/or videos for one or more users to interact with 700. As noted above, a sensor can detect one or more users interacting with the user interface. When detecting a first user and a second user interacting with the user interface, the sensor can detect and/or identify a first user based on a first position and a second user based on a second position 710.

In one embodiment, the sensor can detect objects within an environment around the sensor and/or the computing machine by emitting one or more signals. The sensor can then detect and/or scan for any response generated from the signals reflected off of users in the environment and pass the detected information to the processor and/or the response application. In another embodiment, the sensor can scan or capture a view of one or more of the users and pass the information to the processor and/or the response application. Using the detected information, the processor and/or the response application can identify a number of users and a position of each of the users.

The sensor can then proceed to detect one or more actions from a first position of the first user when detecting a first user input. As noted above, an action can be or include a gesture action, a touch action, a voice action, and/or any additional action detectable by the sensor from a user. In one embodiment, the sensor additionally detects an orientation of a hand or a finger of the first user and/or an angle of approach when detecting a first user input from the first user 720. The sensor will then pass the detected information from the first position to the processor and/or the response application to identify a first user input for a computing machine in response to detecting the first user input from the first position 730.

Additionally, the sensor can detect one or more actions from a second position of the second user when detecting a second user input. In one embodiment, the sensor additionally detects an orientation of a hand or a finger of the second user and/or an angle of approach when detecting a second user input from the first user 740. The sensor will then pass the detected information from the second position to the processor and/or the response application to identify a second user input for a computing machine in response to detecting the second user input from the second position 750. Further, the sensor can detect the first user input and the second user input independently and/or in parallel.

When identifying a first user input and/or a second user input, the processor and/or the response application can access a database. The database can include one or more columns where each column corresponds to a user detected by the sensor. Additionally, each column can include one or more entries which list recognized inputs for a corresponding user, information of the recognized inputs, and a response which is associated with a recognized input. The processor and/or the response application can compare the detected information from the first user position to information included in the first position column and scan for a match when identifying the first user input. Additionally, the processor and/or the response application can compare the detected information from the second user position to information included in the second position column and scan for a match when identifying the second user input.

Once the first user input and/or the second user input have been identified, the processor and/or the response application can identify a first response and/or a second response which can be provided. As noted above, a response can be to execute or reject a recognized first user input or second user input. Additionally, a response can be used by the computing machine to access, execute, modify, and/or delete one or more files, items, and/or functions. When identifying a first response, the processor and/or the response application will identify a response listed to be next to or associated with the recognized first user input. Additionally, when identifying a second response, the processor and/or the response application will identify a response listed to be next to or associated with the recognized second user input.

Once the first response and/or the second response have been identified, the processor and/or the response application can instruct the computing machine to provide the first response to the first user based on the first user input and the first position 760. Additionally, the processor and/or the response application can instruct the computing machine to provide the second response to the second user based on the second user input and the second position 770. When providing a response, the processor and/or the response application can instruct the computing machine to reject or execute a corresponding input. In one embodiment, the display device is additionally configured to render the first response and/or the second response 780. In other embodiments, the method of FIG. 7 includes additional steps in addition to and/or in lieu of those depicted in FIG. 7.

What is claimed is:

1. A method for detecting an input comprising:
identifying a first user based on a first position and a second user based on a second position with a sensor;
providing a first response from a computing machine in response to the sensor detecting a first user input from the first user; and
providing a second response from the computing machine in response to the sensor detecting a second user input from the second user.

2. The method for detecting an input of claim 1 further comprising detecting an orientation of at least one from the group consisting of a hand of the first user and a finger of the first user when detecting the first user input.

3. The method for detecting an input of claim 1 further comprising identifying angle of approaches for the first user input and the second user input.

4. The method for detecting an input of claim 1 further comprising detecting an orientation of at least one from the group consisting of a hand of the second user and a finger of the second user when detecting the second user input.

5. The method for detecting an input of claim 1 further comprising identifying the first user input for the computing machine in response the first user position and identifying the second user input for the computing machine in response to the second user position.

6. The method for detecting an input of claim 5 wherein the computing machine provides the first response to the first user based on the first user input and the first user position.

7. The method for detecting an input of claim 5 wherein the computing machine provides the second response to the second user based on second user input and the second user position.

8. A computing machine comprising:
a sensor configured to detect a first position of a first user and a second position of a second user; and
a processor configured to provide a first response based on the sensor detecting a first user input from the first user position and provide a second response based on the sensor detecting a second user input from the second user position.

9. The computing machine of claim 8 further comprising a display device configured to render at least one from the group consisting of the first response and the second response.

10. The computing machine of claim 9 wherein the display device is configured to render a user interface for the first user and the second user to interact with.

11. The computing machine of claim 9 wherein the display device is configured to render a first user interface in response to the first user position and a second user interface in response to the second user position.

12. The computing machine of claim 8 wherein the sensor is a 3D depth capturing device.

13. The computing machine of claim 8 further comprising a database configured to store at least one recognized input and at least one response corresponding to a recognized input.

14. A computer-readable program in a computer-readable medium comprising:
a response application configured utilize a sensor to detect a first user based on a first position and a second user based on a second position;
wherein the response application is additionally configured to provide a first response based on the sensor detecting a first user input from the first position; and
wherein the response application is further configured provide a second response based on the sensor detecting a second user input from the second position.

15. The computer-readable program in a computer-readable medium of claim 14 wherein the first response provided by the computing machine is different from the second response provided by the computing machine.
